(19) United States
(12) Patent Application Publication
(10) Pub. No.: US 2009/0089108 A1
(43) Pub. Date: Apr. 2, 2009

(54) METHOD AND APPARATUS FOR AUTOMATICALLY IDENTIFYING POTENTIALLY UNSAFE WORK CONDITIONS TO PREDICT AND PREVENT THE OCCURRENCE OF WORKPLACE ACCIDENTS

(76) Inventors: Robert Lee Angell, Salt Lake City, UT (US); James R. Kraemer, Santa Fe, NM (US)

Correspondence Address: DUKE W. YEE, YEE AND ASSOCIATES, P.C., P.O. BOX 802333, DALLAS, TX, 75380, US

(21) Appl. No.: 11/862,608

(22) Filed: Sep. 27, 2007

(51) Int. Cl. G06Q 10/00

(52) U.S. Cl. 705/7

(57) ABSTRACT

A computer implemented method, apparatus, and computer usable program product for predicting an occurrence of a workplace accident. The process monitors current event data derived from a continuous video stream. The current event data comprises metadata describing events occurring at a workplace. The process then compares the current event data with previous event data that describes a set of previous events associated with a previously identified workplace accident. In response to detecting events in the current event data corresponding to at least one event in the set of previous events, the process generates a notification identifying a potential occurrence of the workplace accident.

### CROSS-REFERENCE TO RELATED APPLICATIONS

The present invention is related to the application entitled Intelligent Surveillance System and Method for Integrated Event Based Surveillance, application Ser. No. 11/455,251 (filed Jun. 16, 2006), assigned to a common assignee, and which is incorporated herein by reference.

### BACKGROUND OF THE INVENTION

1. Field of the Invention

The present invention relates generally to an improved data processing system, and in particular, to a computer implemented method and apparatus for processing video and audio data. Still more particularly, the present invention relates to a computer implemented method, apparatus, and computer usable program product for utilizing digital video technology to prevent workplace accidents by automatically identifying potentially unsafe work environments through analysis of event data derived from a continuous video stream.

2. Description of the Related Art

A workplace accident is an unintended event or mishap that occurs at a location where workers are present and working. The location may be, for example, an office building, a chemical plant, a garage, a construction site, or other type of location or facility. Workplace accidents may include, for example, an explosion at a chemical plant, a release of chemicals or toxins into the environment, injury to one or more workers, or any other event that disrupts the processes occurring at the workplace location. Consequences of workplace accidents may include loss of production, loss of equipment, loss of profit, injury or even loss of life.

Workplace accidents may be caused by a complex set of actions, events, or omissions that can be attributed to worker inattentiveness, carelessness, or lack of experience and training. Other times, workplace accidents occur because of equipment failure or any number of events that occur in series or parallel that combine to cause the workplace accident. Understanding the causal effects of workplace accidents is important in preventing the occurrence or recurrence of workplace accidents in the future and providing safe working conditions for workers.

One currently used method for preventing the occurrence of workplace accidents is the implementation of prophylactic rules and regulations designed, in theory, to prevent the occurrence of a workplace accident. For example, workers entering an oil tank at a plant are often required to wear respirators to prevent inhalation of dangerous gases. However, these rules are ineffective for preventing workplace accidents that result from otherwise undetectable or unexpected conditions or events.

Another currently used method for preventing a workplace accident involves the analysis of workplace accidents that have already occurred. Accident investigators identify the cause or causes of the workplace accident through forensic reconstruction and analysis. This costly and time consuming process often requires the investigators to reconstruct the accident scene, analyze production data, perform detailed interviews of witnesses to the accident, and complete a long checklist of tasks in order to deduce the cause of the accident. In some instances, the accident cannot be reconstructed because the clues to the cause of the accident have been destroyed, or because participants or witnesses cannot clearly recall the actions and events leading up to the workplace accident. Thus, the cause of the workplace accident may never be identified and the workplace accident may recur at some point in the future.

### SUMMARY OF THE INVENTION

The illustrative embodiments described herein provide a computer implemented method, apparatus, and computer usable program product for predicting an occurrence of a workplace accident. The process monitors current event data derived from a continuous video stream. The current event data comprises metadata describing events occurring at a workplace. The process then compares the current event data with previous event data that describes a set of previous events associated with a previously identified workplace accident. In response to detecting events in the current event data corresponding to at least one event in the set of previous events, the process generates a notification identifying a potential occurrence of the workplace accident.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network data processing system in which illustrative embodiments may be implemented;

FIG. 2 is a simplified block diagram of a facility in which a set of sensors may be deployed for gathering current event data in accordance with an illustrative embodiment;

FIG. 3 is a block diagram of a data processing system in which the illustrative embodiments may be implemented;

FIG. 4 is a diagram of a smart detection system for generating event data in accordance with an illustrative embodiment of the present invention;

FIG. 5 is a block diagram of a data processing system for predicting and preventing workplace accidents in accordance with an illustrative embodiment;

FIG. 6 is a block diagram of a unifying data model for processing current event data in accordance with an illustrative embodiment;

FIG. 7 is a block diagram of a data flow through a smart detection system in accordance with an illustrative embodiment; and

FIG. 8 is a flowchart of a process for predicting and preventing workplace accidents in accordance with an illustrative embodiment.

### DETAILED DESCRIPTION OF THE PREFERRED EMBODIMENT

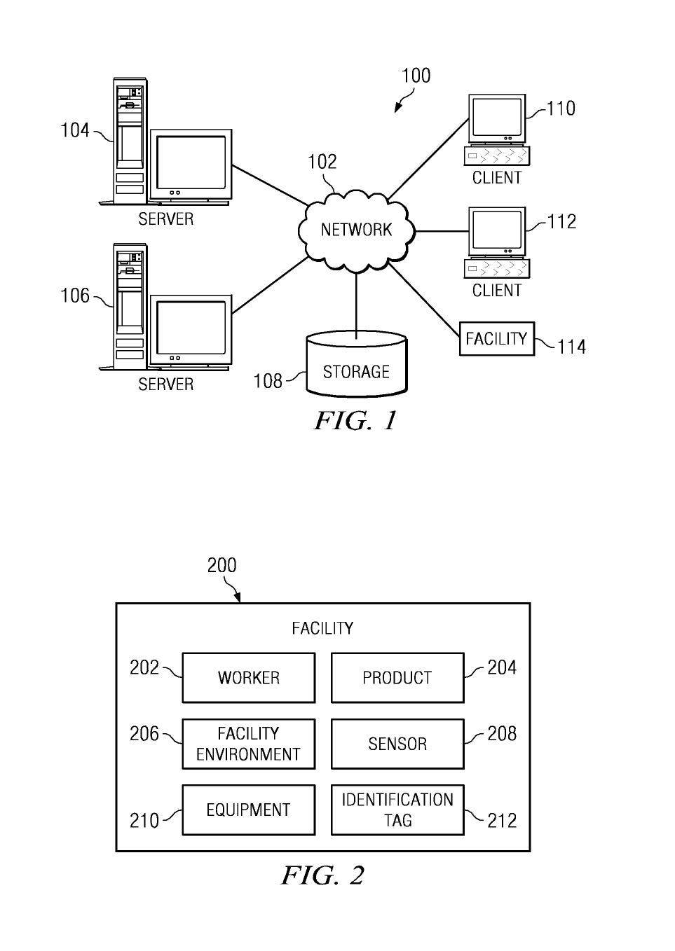

With reference now to the figures, and in particular, with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections such as wire, wireless communication links, or fiber optic cables.

In the depicted example, server 104 and server 106 connect to network 102 along with storage 108. In addition, clients 110 and 112 connect to network 102. Clients 110 and 112 may be, for example, personal computers or network computers. In the depicted example, server 104 provides data, such as boot files, operating system images, and applications to clients 110 and 112. Clients 110 and 112 are clients to server 104 in this example. Network data processing system 100 may include additional servers, clients, and other computing devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 may also be implemented as a number of different types of networks, such as for example, an intranet, a local area network (LAN), or a wide area network (WAN). FIG. 1 is intended as an example, and not as an architectural limitation for the different illustrative embodiments.

Network data processing system 100 also includes facility 114. Facility 114 is a workplace in which workers are present and perform tasks directed to generating one or more products or services. The products may include, for example electronic devices, food, chemicals, clothing, cars, tools, equipment, furniture, or any other product that may be manufactured in a facility. Examples of services that may be generated or performed at facility 114 may include, without limitation, an oil change, a carwash, dry cleaning services, haircuts, gift wrapping services, repair services, or any other type of service. Thus, facility 114 may be a production plant for assembling computers or cars, a petrochemical plant for refining crude oil, a meat packing plant, a construction site, a car repair shop, an office building, or any other facility.

Facility 114 may include one or more facilities, buildings, or other structures, such as parking lots. Facility 114 may include any type of equipment, tool, or vehicle. In addition, facility 114 may include one or more workers trained to perform specific tasks. For example, where facility 114 is an oil refinery configured to process crude oil, workers may include refinery employees responsible for running the day to day operations of the refinery. The workers may also include contractors and subcontractors responsible for maintaining and repairing the towers, drums, pipes, and other equipment of the refinery to insure that the refinery processes are able to continue.

FIG. 2 depicts a simplified block diagram of a facility in which illustrative embodiments may be implemented. In this illustrative embodiment in FIG. 2, facility 200 is a workplace such as facility 114 in FIG. 1. Facility 200 is a workplace at which worker 202 may perform workplace tasks. Worker 202 is one or more workers employed at or otherwise located at facility 200. Workplace tasks are tasks assigned to and performed by worker 202. Workplace tasks may include, for example, maintenance tasks for upkeeping facility 200 or tasks directed to the creation of product 204. Thus, workplace tasks may include, without limitation, washing windows, vacuuming, cleaning dishes, repairing equipment, or assembling computers.

Product 204 may be any tangible object that may be created, assembled, or prepared at facility 200. For example, product 204 may include computers, electronics, toys, meals, buildings, containers, cars, chemicals, or any other object. Product 204 may also be a service product. A service product is a service offered by a service provider, which is generally performed and consumed at a single location. For example, service products may include car washes, oil changes, dry cleaning services, or any other similar types of services. As such, facility 200 may include any location in which tasks are performed to provide product 204. Thus, facility 200 may be, for example, residential or commercial garages, construction yards, training facilities, service facilities, barbershops, or any other facility in which service products may be rendered or performed. Thus, where product 204 is a service product for cleaning out oil tanks, workplace tasks associated with cleaning the oil tank may include venting the oil tank of gasses, donning protective equipment, rinsing out the tank with a pressure washer, and removing the excess sludge with a vacuum truck.

Facility 200 includes one or more strategically placed sensors for gathering detection data at facility 200. In particular, detection data includes audio and video data collected by one or more sensors deployed at facility 200. Detection data is processed by an analysis server, such as analysis server 502 in FIG. 5, to form current event data. Event data is data and metadata. Current event data event describing events occurring at a workplace and/or conditions existing at the workplace. Previous event data is event data describing historical events and/or conditions. Events occurring at a workplace are incidents or proceedings transpiring at a workplace. For example, events occurring at a workplace may include movement of people or equipment. In many instances, the events occurring at a workplace are related to actions of worker 202 while worker 202 is performing workplace tasks at facility 200.

A condition existing at a workplace is a circumstance present at the workplace. For example, a condition existing at a workplace may be a temperature of a piece of equipment or the existence of water after a leak. Conditions existing at a workplace may also relate to events occurring at a workplace. For example, a worker may have accidentally broken a valve, causing the water leak that produces wet conditions.

For example, where the process is the flushing of a chemical tower in a refinery, event data could describe the type of protective equipment worn by worker 202, the type of tools, and the equipment used by worker 202, the manner in which worker 202 used the tools and equipment for flushing out the chemical tower, a presence of chemical fumes escaping from the tower, a temperature of the tower, or any other action, event, or condition associated with the process of flushing out the chemical tower.

In addition, the event data could describe facility environment 206. Facility environment 206 is the ambient conditions of facility 200. Thus, facility environment 206 may include, without limitation, a temperature, humidity, level of lighting, level of ambient noise, or any other condition of facility 200 that may have an effect on the performance of workplace tasks, or that may cause or contribute to events occurring at facility 200. Facility environment 206 may also include the conditions of certain objects within facility 200. For example, event data describing facility environment 206 may also include data describing the temperature of steam exiting a chemical tower or the acidity of product leaking from a nearby drum.

To gather current event data, facility 200 includes sensor 208. Sensor 208 is a set of one or more sensors deployed at facility 200 for monitoring a location, an object, or a person. In particular, sensor 208 captures detection data describing events and conditions at facility 200. Sensor 208 may be located internally and/or externally to facility 200. For example, sensor 208 may be mounted on a wall, ceiling, affixed to equipment or workers, or mounted to any other strategic location within facility 200 to document the actions and omissions of worker 202, facility environment 206, the existence of conditions present at a workplace, and the occurrence of other events that may contribute to workplace accidents.

Sensor 208 may be any type of sensing device for gathering detection data. Sensor 208 may include, without limitation, a camera, a motion sensor device, a sonar, sound recording device, an audio detection device, a voice recognition system, a heat sensor, a seismograph, a pressure sensor, a device for detecting odors, scents, and/or fragrances, a radio frequency identification (RFID) a tag reader, a global positioning system (GPS) receiver, and/or any other detection device for detecting the presence of a person, equipment, or vehicle at facility 200.

A heat sensor may be any type of known or available sensor for detecting body heat generated by a human or animal. A heat sensor may also be a sensor for detecting heat generated by a vehicle, such as an automobile or a motorcycle.

A motion detector may include any type of known or available motion detector device. A motion detector device may include, but is not limited to, a motion detector device using a photo-sensor, radar or microwave radio detector, or ultrasonic sound waves.

A motion detector using ultrasonic sound waves transmits or emits ultrasonic sounds waves. The motion detector detects or measures the ultrasonic sound waves that are reflected back to the motion detector. If a human, animal, or other object moves within the range of the ultrasonic sound waves generated by the motion detector, the motion detector detects a change in the echo of sound waves reflected back. This change in the echo indicates the presence of a human, an animal, or any other object moving within the range of the motion detector.

In one example, a motion detector device using a radar or microwave radio detector may detect motion by sending out a burst of microwave radio energy and detecting the same microwave radio waves when the radio waves are deflected back to the motion detector. If a human, an animal, or any other object moves into the range of the microwave radio energy field generated by the motion detector, the amount of energy reflected back to the motion detector is changed. The motion detector identifies this change in reflected energy as an indication of the presence of a human, animal, or other object moving within the motion detectors range.

A motion detector device, using a photo-sensor, detects motion by sending a beam of light across a space into a photo-sensor. The photo-sensor detects when a human, an animal, or an object breaks or interrupts the beam of light as the human, the animal, or the object moves in-between the source of the beam of light and the photo-sensor. These examples of motion detectors are presented for illustrative purposes only. A motion detector, in accordance with the illustrative embodiments may include any type of known or available motion detector and is not limited to the motion detectors described herein.

A pressure sensor detector may be, for example, a device for detecting a change in weight or mass associated with the pressure sensor. For example, if one or more pressure sensors are imbedded in a sidewalk, Astroturf, or floor mat, the pressure sensor detects a change in weight or mass when a human or an animal steps on the pressure sensor. The pressure sensor may also detect when a human or an animal steps off of the pressure sensor. In another example, one or more pressure sensors are embedded in a parking lot, and the pressure sensors detect a weight and/or mass associated with a vehicle when the vehicle is in contact with the pressure sensor. A vehicle may be in contact with one or more pressure sensors when the vehicle is driving over one or more pressure sensors and/or when a vehicle is parked on top of one or more pressure sensors.

A camera may be any type of known or available camera, including, but not limited to, a video camera for taking moving video images, a digital camera capable of taking still pictures and/or a continuous video stream, a stereo camera, a web camera, and/or any other imaging device capable of capturing a view of whatever appears within the camera's range for remote monitoring, viewing, or recording of a distant or obscured person, object, or area. A continuous video stream is multimedia captured by a video camera that may be processed to extract current event data. The multimedia may be video, audio, or sensor data collected by sensors. In addition, the multimedia may include any combination of video, audio, and sensor data. The continuous video data stream is constantly generated to capture current event data about the environment being monitored.

Various lenses, filters, and other optical devices such as zoom lenses, wide angle lenses, mirrors, prisms, and the like may also be used with the image capture device to assist in capturing the desired view. Devices may be fixed in a particular orientation and configuration, or it may, along with any optical device, be programmable in orientation, light sensitivity level, focus, or other parameters. Programming data may be provided via a computing device, such as server 104 in FIG. 1.

A camera may also be a stationary camera and/or a non-stationary camera. A non-stationary camera is a camera that is capable of moving and/or rotating along one or more directions, such as up, down, left, right, and/or rotate about an axis of rotation. The camera may also be capable of moving to follow or track a person, an animal, or an object in motion. In other words, the camera may be capable of moving about an axis of rotation in order to keep a person or object within a viewing range of the camera lens. In this example, sensor 208 includes non-stationary digital video cameras.

Sensor 208 is coupled to, or in communication with, an analysis server on a data processing system, such as network data processing system 100 in FIG. 1. An exemplary analysis server is illustrated and described in greater detail in FIG. 5, below. The analysis server includes software for analyzing digital images and other data captured by sensor 208 to capture detection data for the creation of current event data relating to events occurring within facility 200.

The audio and video data collected by sensor 208, also referred to as detection data, are sent to smart detection software for processing. The smart detection software processes the detection data to form the current event data. The current event data includes data and metadata describing events captured by sensor 208. The current event data is then sent to the analysis server for additional processing to predict the occurrence of workplace accidents. Workplace accidents may be predicted by identifying and storing a set of previous events that cause or contribute to a specific workplace accident. Thereafter, newly generated current event data captured at a workplace, such as facility 200, may be compared against previous event data describing the set of previous events or conditions known to cause workplace accidents. In this manner, the potential occurrence of a future accident may be predicted and prevented. Previous event data may be generated from the analysis of detection data of a workplace accident that happened in the past. Alternatively, previous event data may be generated from simulations of workplace accidents. In either scenario, previous event data is generated, collected, and stored for use in comparison with current event data describing events and conditions presently at a workplace.

In the illustrative example in FIG. 2, sensor 208 is configured to capture current event data describing events or conditions at facility 200. The events or conditions at facility 200 may relate to equipment 210. Equipment 210 are objects present at facility 200 that may be used to facilitate the performance of workplace tasks. For example, equipment 210 may include, without limitation, computer equipment, machinery, tools, work vehicles, storage vessels, or any other object. Thus, current event data may describe a condition of equipment 210, such as the operating temperature of equipment 210, whether equipment 210 is leaking product, or operating correctly. In addition, current event data may describe the manner in which worker 202 operates equipment 210. Thus, where a workplace task is the assembly electronic devices, worker 202 may be an assembly line worker and equipment 210 may include a soldering iron, a screwdriver, a voltmeter, or any other type of tool or equipment. In another example, where the task is washing a car, then equipment 210 may include a hose, a sponge, a towel, or a squeegee.

Facility 200 may also include identification tag 212. Identification tag 212 is one or more tags associated with objects or persons in facility 200. Thus, identification tag 212 may be utilized to identify an object or person and to determine a location of the object or person. For example, identification tag 212 may be, without limitation, a bar code pattern, such as a universal product code (UPC) or European article number (EAN), a radio frequency identification (RFID) tag, or other optical identification tag. Identification tag 212 may be affixed to or otherwise associated with worker 202, equipment 210, sensor 208, or product 204 where product 204 is a tangible object. The type of identification tag implemented in facility 200 depends upon the capabilities of the image capture device and associated data processing system to process the information.

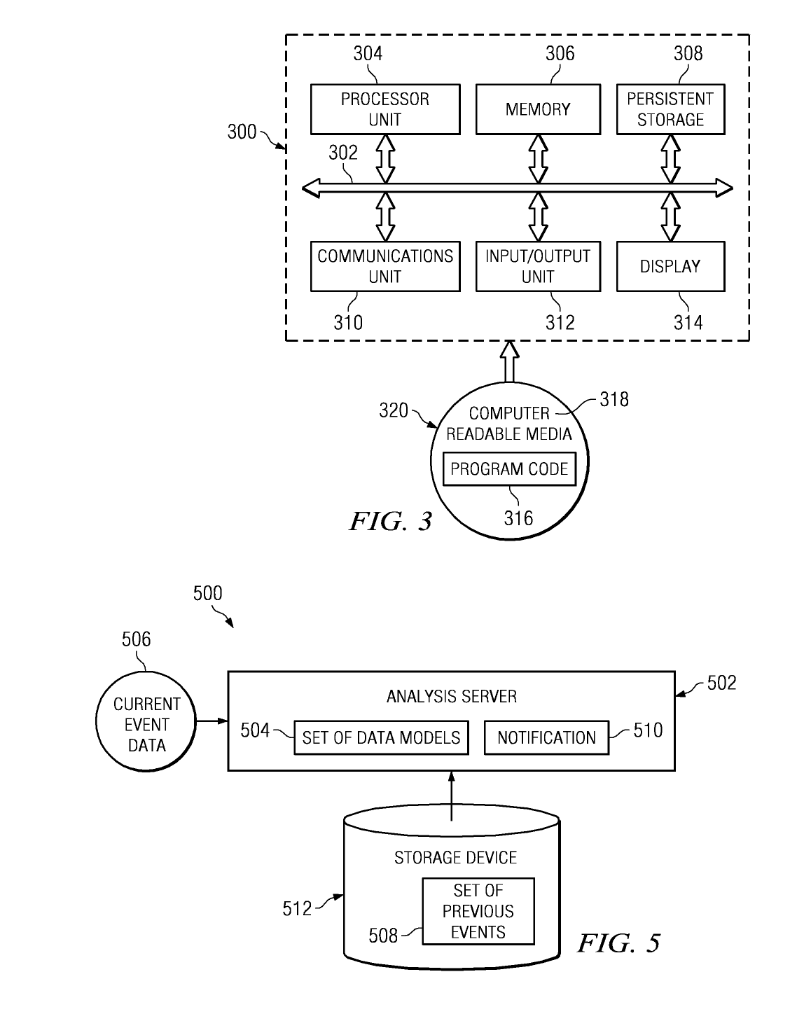

The data processing system, discussed in greater detail in FIG. 3 below, includes associated memory, which may be an integral part, such as the operating memory, of the data processing system or externally accessible memory. Software for tracking objects may reside in the memory and run on the processor. The software in the data processing system maintains a list of all people, sensors, equipment, tools, and any other item of interest in facility 200. The list is stored in a database. The database may be any type of database such as a spreadsheet, a relational database, a hierarchical database, or the like. The database may be stored in the operating memory of the data processing system, externally on a secondary data storage device, locally on a recordable medium such as a hard drive, floppy drive, CD ROM, DVD device, remotely on a storage area network, such as storage 108 in FIG. 1, or in any other type of storage device.

The lists are updated frequently enough to provide a dynamic, accurate, real time listing of the people and objects located within facility 200, as well as the events that occur and conditions that exist within facility 200. The listing of people, objects, and events may be usable to trigger definable actions. For example, a notification system having access to a list of workers performing specific actions within facility 200 may notify an emergency care facility of the occurrence of a serious injury. Consequently, the emergency care facility may dispatch an ambulance to facility 200 and prepare its own facilities to admit a new patient.

With reference now to FIG. 3, a block diagram of a data processing system is shown in which illustrative embodiments may be implemented. Data processing system 300 is an example of a computer, such as server 104 or client 110 in FIG. 1, in which computer usable program code or instructions implementing the processes may be located for the illustrative embodiments. In this illustrative example, data processing system 300 includes communications fabric 302, which provides communication between processor unit 304, memory 306, persistent storage 308, communications unit 310, input/output (I/O) unit 312, and display 314.

Processor unit 304 serves to execute instructions for software that may be loaded into memory 306. Processor unit 304 may be a set of one or more processors or may be a multi-processor core, depending on the particular implementation. Further, processor unit 304 may be implemented using one or more heterogeneous processor systems in which a main processor is present with secondary processors on a single chip. As another illustrative example, processor unit 304 may be a symmetric multi-processor system containing multiple processors of the same type.

Memory 306, in these examples, may be, for example, a random access memory. Persistent storage 308 may take various forms depending on the particular implementation. For example, persistent storage 308 may contain one or more components or devices. For example, persistent storage 308 may be a hard drive, a flash memory, a rewritable optical disk, a rewritable magnetic tape, or some combination of the above. The media used by persistent storage 308 also may be removable. For example, a removable hard drive may be used for persistent storage 308.

Communications unit 310, in these examples, provides for communications with other data processing systems or devices. In these examples, communications unit 310 is a network interface card. Communications unit 310 may provide communications through the use of either or both physical and wireless communications links.

Input/output unit 312 allows for input and output of data with other devices that may be connected to data processing system 300. For example, input/output unit 312 may provide a connection for user input through a keyboard and mouse. Further, input/output unit 312 may send output to a printer. Display 314 provides a mechanism to display information to a user.

Instructions for the operating system and applications or programs are located on persistent storage 308. These instructions may be loaded into memory 306 for execution by processor unit 304. The processes of the different embodiments may be performed by processor unit 304 using computer implemented instructions, which may be located in a memory, such as memory 306. These instructions are referred to as, program code, computer usable program code, or computer readable program code that may be read and executed by a processor in processor unit 304. The program code in the different embodiments may be embodied on different physical or tangible computer readable media, such as memory 306 or persistent storage 208.

Program code 316 is located in a functional form on computer readable media 318 and may be loaded onto or transferred to data processing system 300 for execution by processor unit 304. Program code 316 and computer readable media 318 form computer program product 320 in these examples. In one example, computer readable media 318 may be in a tangible form, such as, for example, an optical or magnetic disc that is inserted or placed into a drive or other device that is part of persistent storage 308 for transfer onto a storage device, such as a hard drive that is part of persistent storage 308. In a tangible form, computer readable media 318 also may take the form of a persistent storage, such as a hard drive or a flash memory that is connected to data processing system 300. The tangible form of computer readable media 318 is also referred to as computer recordable storage media.

Alternatively, program code 316 may be transferred to data processing system 300 from computer readable media 318 through a communications link to communications unit 310 and/or through a connection to input/output unit 312. The communications link and/or the connection may be physical or wireless in the illustrative examples. The computer readable media also may take the form of non-tangible media, such as communications links or wireless transmissions containing the program code.

The different components illustrated for data processing system 300 are not meant to provide architectural limitations to the manner in which different embodiments may be implemented. The different illustrative embodiments may be implemented in a data processing system including components in addition to or in place of those illustrated for data processing system 300. Other components shown in FIG. 3 can be varied from the illustrative examples shown.

For example, a bus system may be used to implement communications fabric 302 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 306 or a cache such as found in an interface and memory controller hub that may be present in communications fabric 302.

In some illustrative examples, data processing system 300 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 308 or a cache such as found in north bridge and memory controller hub 202. A processing unit may include one or more processors or CPUs.

The depicted examples in FIGS. 1-3 are not meant to imply architectural limitations. The hardware in FIGS. 1-3 may vary depending on the implementation. For example, data processing system 300 also may be a tablet computer, laptop computer, or telephone device in addition to taking the form of a PDA. In addition, other internal hardware or peripheral devices, such as flash memory, equivalent non-volatile memory, or optical disk drives and the like, may be used in addition to or in place of the hardware depicted in FIGS. 1 and 3. Also, the processes of the illustrative embodiments may be applied to a multiprocessor data processing system.

While workplace tasks are being performed at a workplace, such as facility 200 in FIG. 2, workplace accidents may occur. Although no facility can entirely eliminate the occurrence of all workplace accidents, a facility may reduce the likelihood that the same or similar type of accident will occur in the future by identifying a set of previous events that cause or contribute to workplace accidents. A set of previous events is one or more events, conditions, or a combination of events and conditions. The set of previous events may be one or more events that occur in parallel or in series.

Events occurring in series are two or more events that form a chain of events. In particular, a first event causes a second event that may cause another event, ad infinitum, until the workplace accident occurs. For example, the workplace accident may be caused by the occurrence of four events that happen in succession. If any of the events of these events that occur in series are out of order or missing, then the workplace accident would not occur.

Events occurring in parallel are one or more events that occur without a particular order, but all of which contribute to the occurrence of a workplace accident. For example, a workplace accident may be the explosion of a reactor containing a volatile liquid. If the explosion occurred because a first worker sealed a pressure relief valve without anyone knowing, and a second worker applied a heat source to the reactor, then the set of previous events associated with the explosion includes the sealing of the pressure relief value and the application of the heat source to the reactor. In this example, the actual order in which the events occurred is irrelevant to the cause of the workplace accident. Thus, the explosion would have occurred even if the heat source was first applied to the reactor and the pressure relief valve was subsequently sealed.

The set of previous events may be stored and referenced to determine whether currently transpiring events or conditions at a workplace may cause a workplace accident. An analysis server may monitor current event data describing these currently transpiring events at the workplace.

If the analysis server detects, from the current event data, events occurring at the workplace that corresponds to at least one event from the set of previous events associated with a workplace accident, then the analysis server may be able to predict that the workplace accident may occur. Consequently, the workplace accident may be prevented. Thus, aspects of the illustrative embodiments recognize that it is advantageous to identify and store previous event data describing a set of previous events associated with a previously identified workplace accident. A set of previous events associated with a previously identified workplace accident is one or more events, conditions, or combination of events or conditions.

Once the set of previous events associated with a workplace accident is identified and stored, then detection of at least one event of the set of previous events associated with the workplace accident may enable an analysis server, such as analysis server 502 in FIG. 5, to predict the occurrence of the workplace accident. Consequently, appropriate safeguards may be implemented to reduce or eliminate the occurrence of the accident in the future. Reducing or eliminating the cause of workplace accidents provides a safer work environment for workers. Safer work environments yield higher morale and productivity, which results in increased profits.

Therefore, the illustrative embodiments described herein provide a computer implemented method, apparatus, and computer usable program product for predicting an occurrence of a workplace accident. The process monitors current event data derived from a continuous video stream. The current event data comprises metadata describing events occurring at a workplace. The process then compares the current event data with previous event data that describes a set of previous events associated with a previously identified workplace accident. In response to detecting events in the current event data corresponding to at least one event in the set of previous events, the process generates a notification identifying a potential occurrence of the workplace accident.

Processing or parsing event data may include, but is not limited to, formatting detection data and/or current event data gathered by sensors, such as sensor 208 in FIG. 2, for utilization and/or analysis in one or more data models, comparing event data to a data model and/or filtering event data for relevant data elements for use in identifying events or conditions at a workplace.

Current event data is derived from the continuous video stream and analyzed in real time. Current event data includes data that has been processed or filtered for analysis in a data model. For example, a data model may not be capable of analyzing raw or unprocessed video images captured by a camera. The video images may need to be processed into data and/or metadata describing the contents of the video images before a data model may be used to organize, structure, or otherwise manipulate data and/or metadata. The video images converted to data and/or metadata that are ready for processing or analysis in a set of data models is an example of current event data.

A set of data models includes one or more data models. A data model is a model for structuring, defining, organizing, imposing limitations or constraints, and/or otherwise manipulating data and metadata to produce a result. A data model may be generated using any type of modeling method or simulation including, but not limited to, a statistical method, a data mining method, a causal model, a mathematical model, a behavioral model, a psychological model, a sociological model, or a simulation model.

As used herein, the term “set” includes one or more. For example, a set of motion detectors may include a single motion detector or two or more motion detectors. In one embodiment, the detectors include a set of one or more cameras located externally to the facility. Video images received from the set of cameras are used for gathering current event data occurring within a facility, such as facility 200 in FIG. 2.

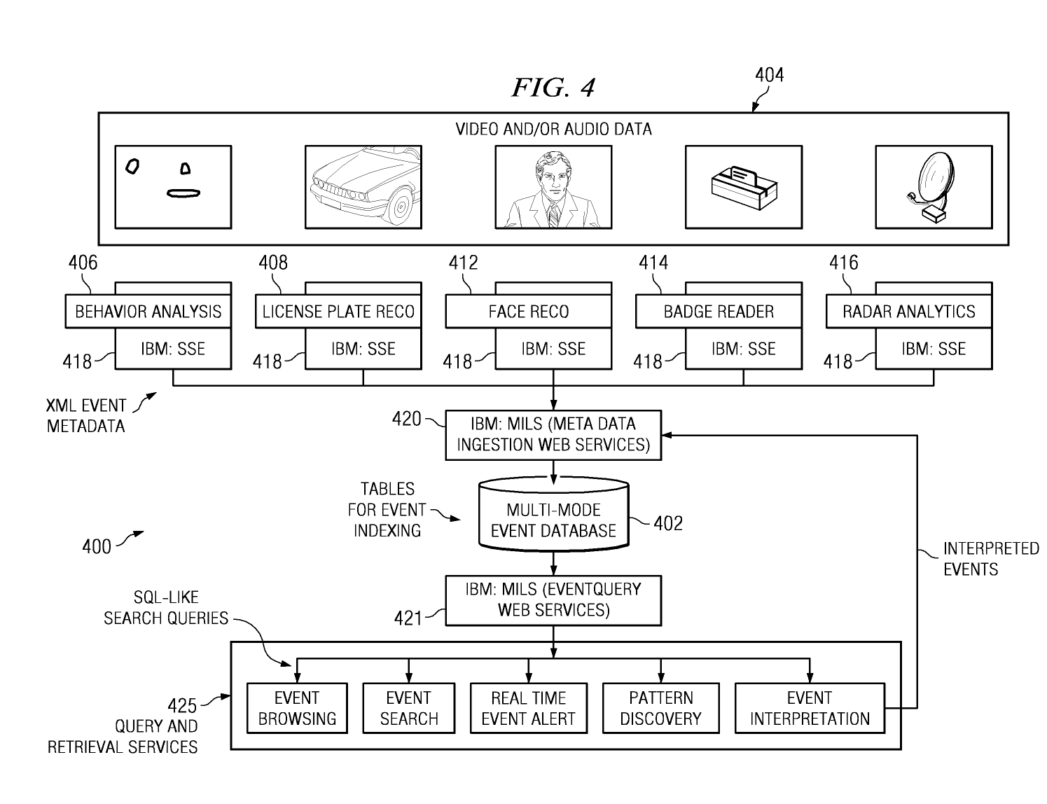

Turning now to FIG. 4, a diagram of a smart detection system is depicted in accordance with an illustrative embodiment. System 400 is a system, such as network data processing system 100 in FIG. 1. System 400 incorporates multiple independently developed event analysis technologies in a common framework. An event analysis technology is a collection of hardware and/or software usable to capture and analyze current event data. For example, an event analysis technology may be the combination of a video camera and facial recognition software. Images of faces captured by the video camera are analyzed by the facial recognition software to identify the subjects of the images.

Smart detection, also known as smart surveillance, is the use of computer vision and pattern recognition technologies to analyze detection data gathered from situated cameras, microphones, or other sensors, such as sensors 208 in FIG. 2. The analysis of the detection data generates events of interest in the environment. For example, an event of interest at a departure drop off area in an airport includes “cars that stop in the loading zone for extended periods of time.” As smart detection technologies have matured, they have typically been deployed as isolated applications which provide a particular set of functionalities.

Smart detection system 400 is a smart detection system architecture for analyzing video images captured by a camera and/or audio captured by an audio detection device. Smart detection system 400 includes software for analyzing audio/video data 404. In this example, smart detection system 400 processes audio/video data 404 associated with a worker, or conditions within a workplace, to create data and metadata used to form query and retrieval services 425. Smart detection system 400 may be implemented using any known or available software for performing voice analysis, facial recognition, license plate recognition, and sound analysis. In this example, smart detection system 400 is implemented as IBM® smart surveillance system (S3) software.

An audio/video capture device is any type of known or available device for capturing video images and/or capturing audio. The audio/video capture device may be, but is not limited to, a digital video camera, a microphone, a web camera, or any other device for capturing sound and/or video images. For example, the audio/video capture device may be implemented as sensor 208 in FIG. 2.

Audio/video data 404 is detection data captured by the audio/video capture devices. Audio/video data 404 may be a sound file, a media file, a moving video file, a media file, a still picture, a set of still pictures, or any other form of image data and/or audio data. Audio/video data 404 may also be referred to as detection data. Audio/video data 404 may include images of a person's face, an image of a part or portion of a car, an image of a license plate on a car, images describing events and conditions at a workplace, and/or one or more images showing a person's behavior. For example, a set of images corresponding to the motions undertaken to perform a process at a workplace may be captured, processed, and analyzed to identify events that may cause or contribute to the occurrence of a workplace accident.

In this example, smart detection system 400 architecture is adapted to satisfy two principles. 1) Openness: The system permits integration of both analysis and retrieval software made by third parties. In one embodiment, the system is designed using approved standards and commercial off-the-shelf (COTS) components. 2) Extensibility: The system should have internal structures and interfaces that will permit the functionality of the system to be extended over a period of time.

The architecture enables the use of multiple independently developed event analysis technologies in a common framework. The events from all these technologies are cross indexed into a common repository or multi-mode event database 402 allowing for correlation across multiple audio/video capture devices and event types.

Smart detection system 400 includes the following illustrative technologies integrated into a single system. License plate recognition technology 408 may be deployed at the entrance to a facility where license plate recognition technology 408 catalogs a license plate of each of the arriving and departing vehicles in a parking lot or roadway associated with the facility. For example, license plate recognition technology 408 may be implemented to track movement of vehicles used in the performance of tasks, such as delivery of objects or people from one location to another.

Behavior analysis technology 406 detects and tracks moving objects and classifies the objects into a number of predefined categories. As used herein, an object may be a human worker or an item, such as equipment or tools usable by the worker to perform a given task. Behavior analysis technology 406 could be deployed on various cameras overlooking a parking lot, a perimeter, or inside a facility.

Face detection/recognition technology 412 may be deployed at entry ways to capture and recognize faces. Badge reading technology 414 may be employed to read badges. Radar analytics technology 416 may be employed to determine the presence of objects.

Events from access control technologies can also be integrated into smart detection system 400. The data gathered from behavior analysis technology 406, license plate recognition 408, Face detection/recognition technology 412, badge reader technology 414, radar analytics technology 416, and any other video/audio data received from a camera or other video/audio capture device is received by smart detection system 400 for processing into query and retrieval services 425.

The events from all the above surveillance technologies are cross indexed into a single repository, such as multi-mode event database 402. In such a repository, a simple time range query across the modalities will extract license plate information, vehicle appearance information, badge information, and face appearance information, thus permitting an analyst to easily correlate these attributes. The architecture of smart detection system 400 also includes surveillance engine (SSE) 418. Smart surveillance engine 418, which may be one or more smart surveillance engines, houses event detection technologies.

Smart detection system 400 further includes middleware for large scale surveillance (MILS) 420 and 421, which provides infrastructure for indexing, retrieving and managing event metadata.

In this example, audio/video data 404 is received from a variety of audio/video capture devices, such as sensor 208 in FIG. 2, and processed in smart surveillance engine 418. Each smart surveillance engine 418 can generate real time alerts and generic event metadata. The metadata generated by smart surveillance engine 418 may be represented using extensible markup language (XML). The XML documents include a set of fields which are common to all engines and others which are specific to the particular type of analysis being performed by smart surveillance engine 418. In this example, the metadata generated by smart surveillance engine 418 is transferred to backend middleware for large scale surveillance system 420. This may be accomplished via the use of, e.g., web services data ingest application program interfaces (APIs) provided by middleware for large scale surveillance 420. The XML metadata is received by middleware for large scale surveillance 420 and indexed into predefined tables in multi-mode event database 402. This may be accomplished using, for example, and without limitation, the DB2™ XML extender, if an IBM® DB2™ database is employed. This permits for fast searching using primary keys. Middleware for large scale surveillance 421 provides a number of query and retrieval services 425 based on the types of metadata available in the database. Query and retrieval services 425 may include, for example, event browsing, event search, real time event alert, or pattern discovery event interpretation. Each event has a reference to the original media resource, such as, without limitation, a link to the video file. This allows a user to view the video associated with a retrieved event.

Smart detection system 400 provides an open and extensible architecture for smart video surveillance. Smart surveillance engine 418 preferably provides a plug and play framework for video analytics. The event metadata generated by smart surveillance engine 418 may be sent to multi-mode event database 402 as XML files. Web services APIs in middleware for large scale surveillance 420 permit for easy integration and extensibility of the metadata. Query and retrieval services 425, such as, for example, event browsing and real time alerts, may use structure query language (SQL) or similar query language through web services interfaces to access the event metadata from multi-mode event database 402.

The smart surveillance engine (SSE) 418 may be implemented as a C++ based framework for performing real time event analysis. Smart surveillance engine 418 is capable of supporting a variety of video/image analysis technologies and other types of sensor analysis technologies. Smart surveillance engine 418 provides at least the following support functionalities for the core analysis components. The support functionalities are provided to programmers or users through a plurality of interfaces employed by the smart surveillance engine 418. These interfaces are illustratively described below.

Standard plug-in interfaces are provided. Any event analysis component which complies with the interfaces defined by smart surveillance engine 418 can be plugged into smart surveillance engine 418. The definitions include standard ways of passing data into the analysis components and standard ways of getting the results from the analysis components. Extensible metadata interfaces are provided. Smart surveillance engine 418 provides metadata extensibility. For example, consider a behavior analysis application which uses detection and tracking technology. Assume that the default metadata generated by this component is object trajectory and size. If the designer now wishes to add color of the object into the metadata, smart surveillance engine 418 enables this by providing a way to extend the creation of the appropriate XML structures for transmission to backend middleware for large scale surveillance 420.

Real time alerts are highly application-dependent. For example, while a person loitering may require an alert in one application, the absence of a guard at a specified location may require an alert in a different application. The smart surveillance engine provides an easy real time alert interfaces mechanism for developers to plug-in for application specific alerts. Smart surveillance engine 418 provides standard ways of accessing event metadata in memory and standardized ways of generating and transmitting alerts to backend middleware for large scale surveillance 420.

In many applications, users will need the use of multiple basic real time alerts in a spatio-temporal sequence to compose an event that is relevant in the user's application context. Smart surveillance engine 418 provides a simple mechanism for composing compound alerts via compound alert interfaces. In many applications, the real time event metadata and alerts are used to actuate alarms, visualize positions of objects on an integrated display and control cameras to get better surveillance data. Smart surveillance engine 418 provides developers with an easy way to plug-in actuation modules which can be driven from both the basic event metadata and by user defined alerts using real time actuation interfaces.

Using database communication interfaces, smart surveillance engine 418 also hides the complexity of transmitting information from the analysis engines to the multi-mode event database 402 by providing simple calls to initiate the transfer of information.

The IBM Middleware for Large Scale Surveillance (MILS) 420 and 421 may include a J2EE™ frame work built around IBM's DB2™ and IBM WebSphere™ application server platforms. Middleware for large scale surveillance 420 supports the indexing and retrieval of spatio-temporal event metadata. Middleware for large scale surveillance 420 also provides analysis engines with the following support functionalities via standard web service interfaces using XML documents.

Middleware for large scale surveillance 420 and 421 provide metadata ingestion services. These are web service calls which allow an engine to ingest events into the middleware for large scale surveillance 420 and 421 system. There are two categories of ingestion services. 1) Index Ingestion Services: This permits for the ingestion of metadata that is searchable through SQL like queries. The metadata ingested through this service is indexed into tables which permit content based searches, such as provided by middleware for large scale surveillance 420. 2) Event Ingestion Services: This permits for the ingestion of events detected in smart surveillance engine 418, such as provided by middleware for large scale surveillance 421. For example, a loitering alert that is detected can be transmitted to the backend along with several parameters of the alert. These events can also be retrieved by the user but only by the limited set of attributes provided by the event parameters.

The middleware for large scale surveillance 420 and/or 421 provides schema management services. Schema management services are web services which permit a developer to manage their own metadata schema. A developer can create a new schema or extend the base middleware for large scale surveillance schema to accommodate the metadata produced by their analytical engine. In addition, system management services are provided by the middleware for large scale surveillance 420 and/or 421.

The schema management services of middleware for large scale surveillance 420 and 421 provide the ability to add a new type of analytics to enhance situation awareness through cross correlation. For example, newly developed equipment or reagents used in a process may not be detectable by existing analytics. Thus, it is important to permit smart detection system 400 to add new types of analytics and cross correlate the existing analytics with the new analytics. To add/register a new type of sensor and/or analytics to increase situation awareness, a developer can develop new analytics and plug them into smart surveillance engine 418, and employ middleware for large scale surveillance schema management service to register new intelligent tags generated by the new smart surveillance engine analytics. After the registration process, the data generated by the new analytics is immediately available for cross correlating with existing index data.

System management services provide a number of facilities needed to manage smart detection system 400 including: 1) Camera Management Services: These services include the functions of adding or deleting a camera from a middleware for large scale surveillance system, adding or deleting a map from a middleware for large scale surveillance system, associating a camera with a specific location on a map, adding or deleting views associated with a camera, assigning a camera to a specific middleware for large scale surveillance server and a variety of other functionalities needed to manage the system. 2) Engine Management Services These services include functions for starting and stopping an engine associated with a camera, configuring an engine associated with a camera, setting alerts on an engine and other associated functionalities. 3) User Management Services: These services include adding and deleting users to a system, associating selected cameras to a viewer, associating selected search and event viewing capacities with a user and associating video viewing privileges with a user. 4) Content Based Search Services: These services permit a user to search through an event archive using a plurality of types of queries.

For the content based search services (4), the types of queries may include: A) Search by Time retrieves all events from query and retrieval services 425 that occurred during a specified time interval. B) Search by Object Presence retrieves the last one hundred events from a live system. C) Search by Object Size retrieves events where the maximum object size matches the specified range. D) Search by Object Type retrieves all objects of a specified type. E) Search by Object Speed retrieves all objects moving within a specified velocity range. F) Search by Object Color retrieves all objects within a specified color range. G) Search by Object Location retrieves all objects within a specified bounding box in a camera view. H) Search by Activity Duration retrieves all events from e query and retrieval services 425 with durations within the specified range. I) Composite Search combines one or more of the above capabilities. Other system management services may also be employed.

Referring now to FIG. 5, a block diagram of a data processing system for predicting the occurrence of a workplace accident is shown, in accordance with an illustrative embodiment. Data processing system 500 is a data processing system, such as data processing system 100 in FIG. 1 and data processing system 300 in FIG. 3.

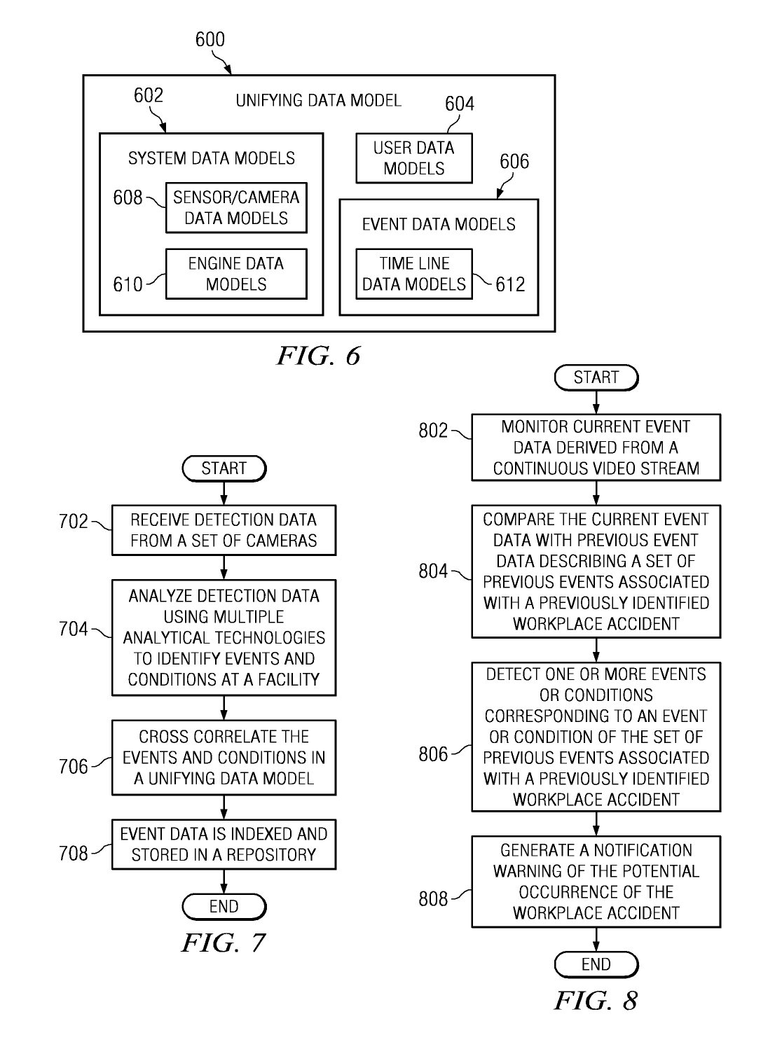

Data processing system 500 includes analysis server 502. Analysis server 502 may be a server, such as server 104 in FIG. 1 or data processing system 300 in FIG. 3. Analysis server 502 includes set of data models 504. Set of data models 504 is one or more data models created a priori or pre-generated for use in processing current event data 506. Set of data models 504 may be generated using statistical, data mining and simulation or modeling techniques. In this example, set of data models 504 includes, but is not limited to, a unifying data model, system data models, event data models, and/or user data models. These data models are discussed in greater detail in FIG. 6 below.

Current event data 506 is data or metadata describing presently occurring events and conditions at a facility, such as facility 200 in FIG. 2. Processing current event data 506 may include, but is not limited to, parsing current event data 506 for data elements, comparing current event data 506 to baseline or comparison models, and/or formatting current event data 506 for utilization and/or analysis in one or more data models in set of data models 504. The processed current event data is monitored to detect the presence of events and conditions at a workplace to predict the occurrence of the workplace accident. Thereafter, remedial actions may be undertaken to prevent the actual occurrence of the workplace accident.

Analysis server 502 monitors current event data 506 to identify events and/or conditions described therein. The events and/or conditions are compared with events or conditions of set of previous events 508. Set of previous events 508 is one or more events, conditions, or a combination of events and conditions, that have been associated with a workplace accident. Set of previous events 508 is stored in storage device 512. Storage device 512 is any device for storing data, such as storage 108 in FIG. 1 and persistent storage 308 in FIG. 3.

If analysis server 502 detects the presence of at least one event in the current event data corresponding to at least one event in set of previous events 508, then analysis server 502 may generate notification 510 disclosing a potential occurrence of the workplace accident. In particular, if set of previous events data 508 describes parallel events that causes or contributes to a workplace accident, then analysis server 502 may generate notification 510 upon detecting one or more events described in set of previous events 508. However, if set of previous events 508 describes a series of events that causes or contributes to a workplace accident, then analysis server generates notification 510 when analysis server 502 detects that the events are occurring in the order set forth in set of previous events 508.

Notification 510 may be generated by at least one of analysis server 502 and a user. In other words, notification 510 may be generated by either analysis server 502 or a human user, or both. Notification 510 may be presented to a worker at a facility, such as worker 202 in facility 200 in FIG. 2. Notification 510 may take the form of text, graphics, video clips, or diagrams illustrating and describing the events or conditions existing at a workplace and how they have been known to cause or contribute to the occurrence of a workplace accident.

Notification 510 may describe remedial actions for avoiding a potential occurrence of the workplace accident. Remedial actions are actions that prevent the occurrence of a workplace accident. For example, a remedial action to prevent the explosion of a sealed vessel may be the opening of a pressure relief valve.

For example, if a chemical storage vessel exploded during the process of filling the vessel, notification 510 may include text describing conditions of the tank. The conditions may include, for example, a temperature of the vessel, an increased pressure of the vessel, the type of chemical being placed into the vessel, and names of all workers assisting in the filling process. Notification 510 may also include photographs or video clips illustrating the manner in which workers performed the filling process. Video clips may indicate, for example, that a worker forgot to check that a pressure release valve was working properly, thereby allowing the pressure of the tank to rise catastrophically.

Turning now to FIG. 6, a block diagram of a unifying data model for processing current event data is depicted in accordance with an illustrative embodiment. The current event data generated by a smart detection system may be processed by one or more data models in a set of data models, such as set of data models 504 in FIG. 5, to detect events or conditions at a workplace that may contribute to the occurrence of a workplace accident. Unifying data model 600 is an example of a data model for processing event data.

In this example, unifying data model 600 has three types of data models, namely; 1) system data models 602 which captures the specification of a given monitoring system, including details like geographic location of the system, number of cameras deployed in the system, physical layout of the monitored space, and other details regarding the facility; 2) user data models 604 models users, privileges and user functionality; and 3) event data models 606 which captures the events that occur in a specific sensor or zone in the monitored space. Each of these data models is described below.

System data models 602 has a number of components. These may include sensor/camera data models 608. The most fundamental component of this sensor/camera data models 608 is a view. A view is defined as some particular placement and configuration, such as a location, orientation, and/or parameters, of a sensor. In the case of a camera, a view would include the values of the pan, tilt and zoom parameters, any lens and camera settings, and position of the camera. A fixed camera can have multiple views. The view “Id” may be used as a primary key to distinguish between events being generated by different sensors. A single sensor can have multiple views. Sensors in the same geographical vicinity are grouped into clusters, which are further grouped under a root cluster. There is one root cluster per middleware for large scale surveillance server.

Engine data models 610 provide a comprehensive security solution, which utilizes a wide range of event detection technologies. Engine data model 610 captures at least some of the following information about the analytical engines: Engine Identifier: A unique identifier assigned to each engine; Engine Type: This denotes the type of analytic being performed by the engine, for example face detection, behavior analysis, and/or LPR; and Engine Configuration: This captures the configuration parameters for a particular engine.

User data models 604 captures the privileges of a given user. These may include selective access to camera views; selective access to camera/engine configuration and system management functionality; and selective access to search and query functions.

Event data models 606 represents the events that occur within a space that may be monitored by one or more cameras or other sensors. Event data models 606 may incorporate time line data models 612 for associating the events with a time. By associating the events with a time, an integrated event may be defined. An integrated event is an event that may include multiple sub-events. Time line data model 612 uses time as a primary synchronization mechanism for events that occur in the real world, which is monitored through sensors. The basic middleware for large scale surveillance schema allows multiple layers of annotations for a given time span.

Turning now to FIG. 7, a process for generating event data by a smart detection system is depicted, in accordance with an illustrative embodiment. The process in FIG. 7 may be implemented by a smart detection system, such as smart detection system 400 in FIG. 4.

The process begins by receiving detection data from a set of cameras (step 702). The process analyzes the detection data using multiple analytical technologies to identify events and conditions at a facility (step 704). The multiple technologies may include, for example, a behavior analysis engine, a license plate recognition engine, a face recognition engine, a badge reader engine, and/or a radar analytic engine.

The events and conditions at the facility are cross correlated in a unifying data model (step 706). Cross correlating provides integrated situation awareness across the multiple analytical technologies. The cross correlating may include correlating events to a time line to associate events to define an integrated event. The event data is indexed and stored in a repository, such as a database (step 708) with the process terminating thereafter.

In the example in FIG. 7, the database can be queried to determine an integrated event that matches the query. This includes employing cross correlated information from a plurality of information technologies and/or sources. New analytical technologies may also be registered. The new analytical technologies can employ models and cross correlate with existing analytical technologies to provide a dynamically configurable surveillance system.

In this example, detection data is received from a set of cameras. However, in other embodiments, detection data may come from other detection devices, such as, without limitation, a badge reader, a microphone, a motion detector, a heat sensor, or a radar.

Turning now to FIG. 8, a process for predicting the occurrence of a workplace accident is depicted in accordance with an illustrative embodiment. This process may be implemented by an analysis server, such as analysis server 502 in FIG. 5.

An analysis server monitors current event data derived from a continuous video stream (step 802). The continuous video stream may be captured by a set of sensors, such as sensor 208 in FIG. 2.

The process then compares the current event data with previous event data describing a set of previous events associated with a previously identified workplace accident (step 804). The previously identified workplace accident may have been an accident that already occurred at a workplace, such as facility 200 in FIG. 2. In addition, the workplace accident may be a simulated accident. In either case, previous event data associated with the workplace accident are stored for comparison with current event data describing events and conditions at a workplace.

The process detects one or more current events or conditions corresponding to an event or condition of the set of previous events associated with a previously identified workplace accident (step 806) and then generates a notification warning of the potential occurrence of the workplace accident (step 808) and the process terminates thereafter. The notification may be sent to workers, supervisors, or systems administrators. In addition, the notification may contain instructions identifying the potential workplace accident, the set of previous events that have been known to cause the workplace accident, the events or conditions currently existing at a workplace, and any remedial actions that may prevent the workplace accident.

The flowcharts and block diagrams in the different depicted embodiments illustrate the architecture, functionality, and operation of some possible implementations of methods, apparatus, and computer usable program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

The illustrative embodiments described herein provide a computer implemented method, apparatus, and computer usable program product for predicting an occurrence of a workplace accident. The process monitors current event data derived from a continuous video stream. The current event data comprises metadata describing events occurring at a workplace. The process then compares the current event data with previous event data that describes a set of previous events associated with a previously identified workplace accident. In response to detecting events in the current event data corresponding to at least one event in the set of previous events, the process generates a notification identifying a potential occurrence of the workplace accident.

The illustrative embodiments permit facilities to capture event data describing events and conditions occurring at a workplace. Such information may then be compared to a set of previous events that have been known to cause workplace accidents. Once an event or condition occurring at a workplace facility has been correlated with an event or condition from a set of previous events known to cause workplace accidents, the occurrence of that workplace accident may be predicted. Remedial actions may then be performed to prevent the workplace accident. In this manner, facilities may be able to predict and prevent workplace accidents, thereby providing a safer work environment for workers at a workplace.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Further, a computer storage medium may contain or store a computer readable program code such that when the computer readable program code is executed on a computer, the execution of this computer readable program code causes the computer to transmit another computer readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for predicting an occurrence of a workplace accident, the computer implemented method comprising:
monitoring current event data derived from a continuous video stream, wherein the current event data comprises metadata describing events occurring at a workplace;
comparing the current event data with previous event data, wherein the previous event data describes a set of previous events associated with a previously identified workplace accident; and
responsive to detecting events in the current event data corresponding to at least one event in the set of previous events, generating a notification identifying a potential occurrence of the workplace accident.

2. The computer implemented method of claim 1, wherein the current event data further comprises metadata describing conditions at the workplace.

3. The computer implemented method of claim 1, wherein the set of previous events comprises events occurring in parallel.

4. The computer implemented method of claim 1, wherein the set of previous events comprises events occurring in series.

5. The computer implemented method of claim 1, wherein the notification is generated by at least one of an analysis server and a human user.

6. The computer implemented method of claim 1, wherein the notification identifies remedial actions for avoiding the potential occurrence of the workplace accident.

7. The computer implemented method of claim 1, further comprising:
receiving the video data from a set of sensors associated with the workplace; and
analyzing the video data to identify the current event data, wherein analyzing the video data comprises generating the metadata describing events occurring at the workplace.

8. The computer implemented method of claim 7, wherein the set of sensors comprises a set of digital video cameras.

9. The computer implemented method of claim 7 wherein analyzing the video data comprises processing the event data using at least one of a statistical method, a data mining method, a causal model, a mathematical model, or a simulation model.

10. A computer program product comprising:
a computer usable medium including computer usable program code for predicting an occurrence of a workplace accident, the computer program product comprising:
computer usable program code for monitoring current event data derived from a continuous video stream, wherein the current event data comprises metadata describing events occurring at a workplace;
computer usable program code for comparing the current event data with previous event data, wherein the previous event data describes a set of previous events associated with a previously identified workplace accident; and
computer usable program code for generating a notification identifying a potential occurrence of the workplace accident in response to detecting events in the current event data corresponding to at least one event in the set of previous events.

11. The computer program product of claim 10, wherein the current event data further comprises metadata describing conditions at the workplace.

12. The computer program product of claim 10, wherein the set of previous events comprises events occurring in parallel.

13. The computer program product of claim 10, wherein the set of previous events comprises events occurring in series.

14. The computer program product of claim 10, wherein the notification is generated by at least one of an analysis server and a human user.

15. The computer program product of claim 10, wherein the notification identifies remedial actions for avoiding the potential occurrence of the workplace accident.

16. The computer program product of claim 10, further comprising:
computer usable program code for receiving the video data from a set of sensors associated with the workplace;
computer usable program code for analyzing the video data to identify the event data, wherein analyzing the video data comprises generating the metadata describing events occurring at the workplace.

17. The computer program product of claim 16, wherein the set of sensors comprises a set of digital video cameras.

18. The computer program product of claim 16, wherein the computer usable program code for analyzing the video data comprises computer usable program code for processing the event data using at least one of a statistical method, a data mining method, a causal model, a mathematical model, or a simulation model.

19. A system for predicting an occurrence of a workplace accident, the system comprising:
a set of sensors;
a database, wherein the database stores event data collected by the set of sensors; and
an analysis server, wherein the analysis server monitors current event data derived from a continuous video stream, wherein the current event data comprises metadata describing events occurring at a workplace; compares the current event data with previous event data, wherein the previous event data describes a set of previous a set of previous events associated with a previously identified workplace accident; and generates a notification identifying a potential occurrence of the workplace accident in response to detecting events in the current event data corresponding to at least one event in the set of previous events.

20. The system of claim 19, wherein the set of sensors comprises a set of digital video cameras.
